(19) United States
(12) Patent Application Publication
(10) Pub. No.: US 2023/0064103 A1
(43) Pub. Date: Mar. 2, 2023

(54) APPARATUS AND METHODS FOR CLEAN TRANSFER OF CENTRIFUGED MATERIALS

(71) Applicant: ENTEGRIS, INC., Billerica, MA (US)

(72) Inventor: Nicholas Coscia, Lexington, MA (US)

(21) Appl. No.: 17/894,905

(22) Filed: Aug. 24, 2022

Related U.S. Application Data
(60) Provisional application No. 63/237,416, filed on Aug. 26, 2021.

(51) Int. Cl. B04B 11/04; B01L 3/00; B04B 5/04

(52) U.S. Cl. CPC B04B 11/04; B01L 3/50215; B04B 5/0407; B01L 2200/026; B01L 2300/046; B01L 2300/0681; B01L 2400/0605

(57) ABSTRACT

A transfer container for a fluid includes a tube, the tube including a conical portion at one end, the tube defining an interior space and one or more fluid passages configured to allow flow of fluid into or out of the interior space of the tube. The transfer container also includes a connector configured to seal the end of the conical portion when the connector is joined only to the conical portion and a pressure control mechanism configured to increase or decrease a pressure in the interior space of the tube. The transfer container can be used in a method including connecting fluid lines to the fluid passages, adding a fluid including cryoprotectant and cells, centrifuging the transfer container, and then connecting the transfer container to a second fluid transfer container containing another fluid. This allows the sterile transfer of fluids and separation of cells from cryoprotectant.

### PRIORITY

This disclosure claims priority to U.S. Provisional Patent Application No. 63/237,416 with a filing date of Aug. 26, 2021.

### FIELD

This disclosure is directed to apparatuses and methods for clean transfer of centrifuged materials, particularly conical tubes and/or syringes and use thereof in handling bioprocess fluids.

### BACKGROUND

Bioprocess fluids can be frozen during some processing or storage steps. The bioprocess fluids can include cryoprotectants to help preserve cells or other components of the bioprocess fluid when frozen. While the cryoprotectants can preserve the cells or other components during the freezing process, they can be toxic to cells or otherwise adversely affect components of interest in the fluid when the fluid is thawed. Currently, ordinary conical tubes and syringes can be used to separate cryoprotectant and other components of bioprocess fluids. However, current methods allow the contact of air with the bioprocess fluid and cannot be guaranteed to be sterile by themselves.

### SUMMARY

This disclosure is directed to apparatuses and methods for clean transfer of centrifuged materials, particularly conical tubes and/or syringes and use thereof in handling bioprocess fluids.

By using tube connections and connectors such as swabable valves, conical tubes and/or syringes according to embodiments can allow the transfer of cells or other components of interest from one medium (for example a medium containing a cryoprotectant) to another environment (such as another medium which does not include the cryoprotectant). This can reduce the risk of contamination and simplify handling processes, such as avoiding use of a glove box or other such sterile environment to perform the transfer of fluid following thawing.

In an embodiment, a fluid transfer system includes a first fluid transfer container. The first fluid transfer container includes a tube, the tube including a conical portion at one end, the tube defining an interior space. The first fluid transfer container also includes one or more fluid passages configured to allow flow of fluid into or out of the interior space of the tube. The first fluid transfer container further includes a connector disposed at an end of the conical portion, the connector configured to seal the end of the conical portion when the connector is joined only to the conical portion. The first fluid transfer container further includes a pressure control mechanism configured to increase or decrease a pressure in the interior space of the tube.

In an embodiment, the connector includes at least part of a swabable valve.

In an embodiment, the fluid transfer system further includes a cap configured to cover the connector and at least part of the conical portion. In an embodiment, the cap is configured to be received in a centrifuge.

In an embodiment, the fluid transfer system further includes a transfer assembly and a fluid line connected to the transfer assembly and to one of the one or more fluid passages.

In an embodiment, the fluid transfer system further includes a media supply and a fluid line connected to the media supply and to one of the one or more fluid passages.

In an embodiment, the fluid transfer system further includes a vent including a filter, and a fluid line connected to the vent and to one of the one or more fluid passages.

In an embodiment, the pressure control mechanism includes a plunger movably disposed within the tube. In this embodiment, the one or more fluid passages are disposed on the plunger, the plunger includes a socket, and the pressure control mechanism further includes a plunger handle configured to be attached to the plunger at the socket. The plunger handle is configured such that a space is formed between the plunger handle and the tube, and the space is configured to accommodate one or more fluid lines configured to be joined to the one or more fluid passages.

In an embodiment, the pressure control mechanism is a syringe including a syringe tube, a plunger, and a luer connector, the luer connector configured to be connected to a transfer container luer connector provided on the transfer container.

In an embodiment, the fluid transfer system further includes a second fluid transfer container. The second fluid transfer container includes a second tube, the second tube including a second conical portion at one end, the second tube defining a second internal space and a second connector disposed at an end of the second conical portion. The connector is configured to seal the end of the second conical portion when the connector is joined only to the second conical portion. The connector of the first fluid transfer container and the second connector are configured to be joined to one another.

In an embodiment, the connector of the first fluid transfer container forms a first portion of a swabable valve and the second connector forms a second portion of the swabable valve.

In an embodiment, a method of handling a fluid includes connecting one or more fluid lines to fluid passages of a first fluid transfer container. The method further includes directing a first fluid through at least one of the one or more fluid lines into the transfer container, the first fluid including previously frozen cells and first media, the first media including a cryoprotectant and centrifuging the first fluid transfer container when it contains the first fluid. The method also includes introducing a second fluid into a second fluid transfer container, the second fluid including a second media, the second media containing a lower concentration of the cryoprotectant than the first media. The method further includes connecting the first fluid transfer container to the second fluid transfer container and transferring at least a portion of the first fluid into the second fluid transfer container.

In an embodiment, the method further includes placing a cap over the first connector prior to the centrifuging of the syringe.

In an embodiment, connecting the first fluid transfer container to the second fluid transfer container includes joining the first connector to a second connector of a second fluid transfer container. In an embodiment, the first connector is a first portion of a swabable valve, and the second connector is a second portion of the swabable valve.

In an embodiment, the second media does not contain any of the cryoprotectant.

In an embodiment, the method further includes directing the previously frozen cells and the second media out of the second fluid transfer container by pressurizing an internal space of the second fluid transfer container, wherein the internal space of the second fluid transfer container is pressurized by driving a plunger located within the internal space of the second fluid transfer container.

In an embodiment, the method further includes directing the previously frozen cells and the second media out of the second fluid transfer container by pressurizing an internal space of the second fluid transfer container, wherein the internal space of the second fluid transfer container is pressurized by driving a plunger of a syringe, the syringe being fluidly connected to the second fluid transfer container by way of a luer connection.

### DRAWINGS

FIG. 1 shows an apparatus for transfer of fluids according to an embodiment.

FIG. 2 shows an apparatus for transfer of fluids according to another embodiment.

FIG. 3 shows a system for transfer of fluids according to an embodiment.

FIG. 4 shows a flowchart of a method for clean transfer of fluids according to an embodiment.

FIG. 5A shows a system for transfer of fluids during filling of an apparatus for fluid transfer according to an embodiment.

FIG. 5B shows an apparatus for transfer of fluids according to an embodiment when it contains fluid prior to centrifugation.

FIG. 5C shows an apparatus for transfer of fluids according to an embodiment when it contains fluid following centrifugation.

FIG. 5D shows an apparatus for transfer of fluids when it is included in a system for transfer of fluids according to an embodiment.

FIG. 5E shows the second apparatus for transfer of fluids included in the system of FIG. 5C, following transfer of the fluid.

### DETAILED DESCRIPTION

This disclosure is directed to apparatuses and methods for clean transfer of centrifuged materials, particularly conical tubes and/or syringes and use thereof in handling bioprocess fluids.

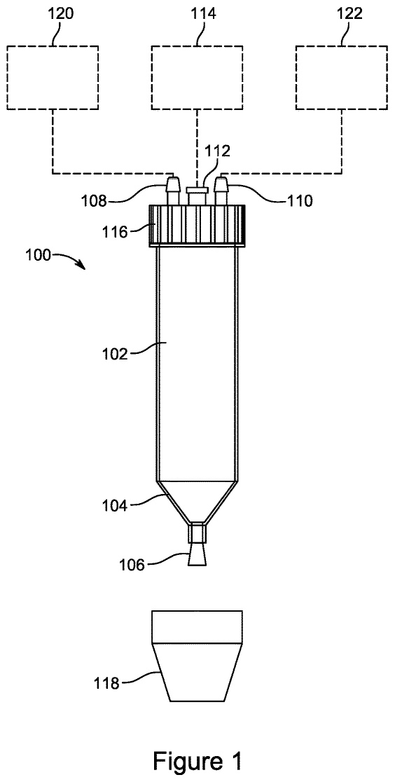

FIG. 1 shows an apparatus for transfer of fluids according to an embodiment. Apparatus 100 includes a body 102 having a tapered tip 104 and a connector 106 at an end of tip 104. Apparatus 100 also includes a first fluid passage 108, a second fluid passage 110, and a pressure control connector 112. Pressure source 114 can be connected to pressure control connector 112. In the embodiment shown in FIG. 1, the first fluid passage 108, second fluid passage 110, and pressure control connector 112 are formed in an endcap 116 attached at an end of body 102 opposite the tapered tip 104. A cover 118 can be provided for apparatus 100.

Apparatus 100 can be used as part of a fluid transfer system. In an embodiment, the fluid transfer system can include multiple identical apparatuses such as apparatus 100. In an embodiment, the fluid transfer system can further include one or more of a fluid storage 120 and/or a vacuum source 122 connected to the first fluid passage 108 or the second fluid passage 110. In embodiments, the apparatus 100 can be filled with thawed fluids for a bioreaction, used for centrifugation, and/or filled with replacement media, and/or receive a portion of bioreaction fluids.

Body 102 defines an internal space which can accommodate a fluid. Body 102 can be made of any suitable material, such as a polymer material. In an embodiment, the material used in body 102 can be selected based on compatibility with the fluids being handled using apparatus 100. The body 102 can include at least a portion having a cylindrical shape. Body 102 includes tapered tip 104 at one end. Tapered tip 104 is provided at an end of body 104. In an embodiment, tapered tip 104 has a conical shape.

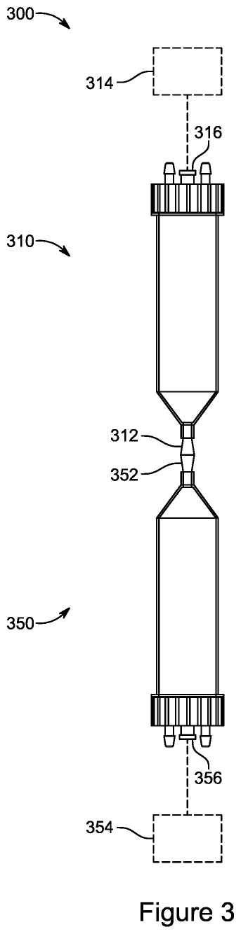

Connector 106 is provided at an end of tapered tip 104. Connector 106 can be configured to selectively allow fluid to be drawn into or driven out of body 102. In an embodiment, connector 106 can be configured to allow the fluid to be drawn into or driven out of body 102 only when the connector 106 is joined to a corresponding connector. In an embodiment, connector 106 includes at least a portion of a swabable valve. In an embodiment, the connector 106 can include a check valve or an aseptic connector. In an embodiment, connector 106 of a first apparatus 100 can be connected to a corresponding connector of a second apparatus (as shown in FIG. 3 and described below) such that fluid can be exchanged between these apparatuses.

First fluid passage 108 is a fluid passage configured to allow fluid to pass into or out of the apparatus 100. The first fluid passage 108 can include one or more tube retention features allowing a tube to be joined to the first fluid passage 108. The tube retention features can include one or more sets of hose barbs, a luer connection, at least a portion of a quick disconnect system, or any other suitable features for retaining a tube so that the tube can supply fluid to or receive fluid from the first fluid passage 108.

Second fluid passage 110 is another fluid passage also configured to allow fluid to pass into or out of the apparatus 100. Second fluid passage 110 can include one or more tube retention features. The tube retention features can include one or more sets of hose barbs, a luer connection, at least a portion of a quick disconnect system, or any other suitable features for retaining a tube so that the tube can supply fluid to or receive fluid from the second fluid passage 110. In an embodiment, the second fluid passage 110 can have structure identical to the first fluid passage 108. In an embodiment, the second fluid passage 110 can differ from the first fluid passage 108 in one or more of length, diameter, connection features provided, or any other suitable feature.

Pressure control connector 112 is a connector configured to form a connection with pressure source 114 such that the pressure source 114 can increase or decrease pressure within body 102. Pressure source 114 is a source of positive or negative pressure that can be connected to the apparatus 100 by way of pressure control connector 112. In an embodiment, pressure source 114 includes a syringe that can supply positive pressure when a plunger is depressed or provide negative pressure when the plunger is retracted. In an embodiment, pressure source 114 can be a vacuum, a pump, or any other suitable source of positive and/or negative pressure. Pressure source 114 and pressure control connector 112 can be used to draw fluid into or expel fluid from body 102. In an embodiment, pressure control connector 112 is a luer connection. In an embodiment, pressure control connector 112 includes quick disconnection features allowing the attachment and removal of the pressure source 114. In an embodiment, pressure control connector is an aperture that can receive a tip of a tube from pressure source 114.

Endcap 116 can enclose an end of body 102 opposite the tapered tip 104. Endcap 116 can be joined to body 102 by any suitable temporary or permanent connection, for example, a weld or a mechanical connection such as a threaded connection, a snap fit, or the like. The connection of endcap 116 to body 102 can be a sealed connection, such as the weld described above, or through inclusion of a seal in the mechanical connection. In an embodiment, the endcap 116 can include the first fluid passage 108, the second fluid passage 110, and/or the pressure control connector 112.

Cap 118 can optionally be provided with apparatus 100. Cap 118 is configured to cover at least the connector when it is attached to apparatus 100. In an embodiment, cap 118 can further cover at least some of tapered tip 104 when it is attached to apparatus 100. Cap 118 can be configured to be received in a centrifuge such that apparatus 100 can be held securely in the centrifuge and the centrifuge can be used to separate contents of apparatus 100. Cap 118 can be configured to fit securely on apparatus 100, for example forming an interference or snap fit on body 102, for example at tapered tip 104.

Optionally, the apparatus 100 can be connected to a fluid storage 120 by way of one of first fluid passage 108 or second fluid passage 110. In an embodiment, the connection can be made by attaching a tube from the fluid storage 120 to the tube retention, such as hose barbs, luer connections, or the like, provided on the first or second fluid passage 108, 110. The fluid storage 120 can be configured to store or receive bioreaction fluid. In an embodiment, the fluid storage 120 is a bag containing bioreaction fluid that has been thawed following cryogenic storage or processing steps. In an embodiment, the thawed bioreaction fluid can include a cryoprotectant, media, and cells. In an embodiment, the fluid storage 120 contains media for cells of the thawed bioreaction fluid that does not include cryoprotectant. In an embodiment, fluid storage 120 can include multiple sources of fluid that are combined in apparatus 100.

Optionally, the apparatus 100 can be connected to a vacuum source 122 by way of one of first fluid passage 108 or second fluid passage 110. The connection can be made by attaching a tube from vacuum source 122 to the tube retention provided on first or second fluid passage 108, 110. In an embodiment, vacuum source 122 can include a filter. In an embodiment, vacuum source 122 can be used to provide a vacuum to draw fluid from fluid storage 120 into body 102. In an embodiment, vacuum source 122 can be replaced with ventilation allowing pressure to be relieved when fluid is transferred into body 102 from fluid storage 120.

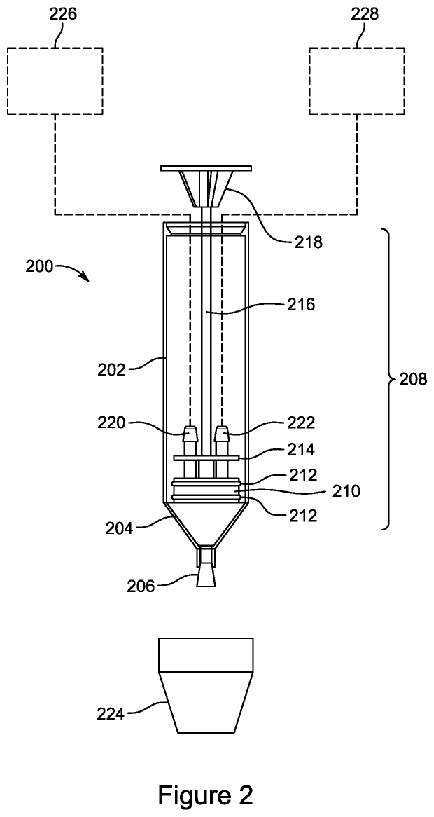

FIG. 2 shows an apparatus for transfer of fluids according to another embodiment. Apparatus 200 includes a body 202 including a tapered tip 204 and a connector 206. Apparatus 200 further includes a plunger assembly 208, including a plunger 210, one or more seals 212, a mechanical connection interface 214 on the plunger 210, a shaft 216, and a plunger handle 218. A first fluid passage 220 and a second fluid passage 222 can be provided on the plunger 210. A cap 224 can be provided with apparatus 200. Apparatus 200 can optionally be connected to one or more of fluid storage 226 and/or vacuum source 228.

Apparatus 200 can be used as part of a fluid transfer system. In an embodiment, the fluid transfer system can include multiple identical apparatuses such as apparatus 200, or other apparatuses such as those described herein, including, as a non-limiting example, apparatus 100 described above and shown in FIG. 1. In an embodiment, the fluid transfer system can further include one or more of a fluid storage 226 and/or a vacuum source 228 connected to the first fluid passage 220 or the second fluid passage 222. In embodiments, the apparatus 200 can be filled with thawed fluids for a bioreaction, used for centrifugation, and/or filled with replacement media, and/or receive a portion of bioreaction fluids.

Body 202 at least partially defines an internal space which can accommodate a fluid. Body 202 can be configured to accommodate plunger 210 such that plunger 210 is slidable within body 202, with plunger 210 and body 202 together defining the internal space that can accommodate the fluid. Body 202 can be made of any suitable material, such as a polymer material. In an embodiment, the material used in body 202 can be selected based on compatibility with the fluids being handled using apparatus 200. The body 202 can include at least a portion having a cylindrical shape. Body 202 includes tapered tip 204 at one end. Tapered tip 204 is provided at an end of body 104. In an embodiment, tapered tip 204 has a conical shape.

Connector 206 is provided at an end of tapered tip 204. Connector 206 can be configured to selectively allow fluid to be drawn into or driven out of body 202. In an embodiment, connector 206 can be configured to allow the fluid to be drawn into or driven out of body 202 only when the connector 206 is joined to a corresponding connector. In an embodiment, connector 206 includes at least a portion of a swabable valve. In an embodiment, connector 206 can include a check valve or an aseptic connector. In an embodiment, connector 206 of a first apparatus 200 can be connected to a corresponding connector of a second apparatus (as shown in FIG. 3 and described below) such that fluid can be exchanged between these apparatuses.

Plunger assembly 208 is an assembly allowing a plunger 210 to be provided in a space defined by body 202 and movement of the plunger 210 therein. Plunger assembly 208 includes plunger 210, one or more seals 212, shaft 216, and plunger handle 218.

Plunger 210 is configured to fit within body 202 such that plunger 210 and body 202 define an internal space that can accommodate a fluid. The plunger 210 is slidable within body 202 such that the volume of the internal space can be adjusted by movement of the plunger 210, for example to draw fluid into or expel fluid from the internal space. Plunger 210 can include first fluid passage 220 and/or second fluid passage 222 passing through the plunger 210 such that the fluid passages allow fluid to pass into or out of the internal space defined by plunger 210 and body 202. The first fluid passage 220 and/or the second fluid passage 222 can include hose retention that is configured to allow fluid lines to be joined to the respective fluid passages 220, 222. The hose retention can be any suitable connection for fluid lines. As a non-limiting example, the hose retention can include hose barbs.

The plunger 210 includes mechanical connection interface 214. Mechanical connection interface 214 is any suitable interface for joining shaft 216 to plunger 210 through a mechanical connection. The mechanical connection can be a connection that is capable of being made when plunger 210 is placed in body 202 and/or while fluid lines are connected to first fluid passage 220 and/or second fluid passage 222. As non-limiting examples, mechanical connection of shaft 216 to plunger 210 can be provided by snaps, detents, threading, or the like with corresponding features for such connection provided on the respective portions of shaft 216 and at mechanical connection interface 214 of plunger 210. In an embodiment, mechanical connection interface 214 is a threaded connector configured to receive and engage with a threaded end of the shaft 216.

One or more seals 212 can be provided to form a seal between the body 202 and the plunger 210. The seals can be any suitable seals, such as O-rings, gaskets, or the like. The seals 212 can be provided in channels formed about a perimeter of the plunger 210 facing towards body 202. In an embodiment, one seal 212 is present between plunger 210 and body 202. In an embodiment, multiple seals are present between plunger body 210 and body 202. Where multiple seals 212 are used, the seals can be positioned to reduce rocking or twisting of plunger 210 along the path that plunger 210 can be slid through body 202. In an embodiment, the seals 212 can be distributed along the surface of plunger 210 in a direction corresponding to the longitudinal direction of body 202.

Shaft 216 is a shaft for the plunger assembly 208. When joined to plunger 210, shaft 216 allows force to be transferred to plunger 210 such that plunger 210 can be moved within body 202. Shaft 216 can be sized smaller than the internal space of the portion of body 202 through which plunger 210 is movable. In an embodiment, shaft 216 is sized such that fluid lines connected to first and second fluid passages 220, 222 can extend out of body 202 without interference from shaft 216. Shaft 216 can be configured to be mechanically joined to plunger 210 at mechanical connection interface 214, for example by inclusion of appropriate features such as threading, detents, flanges, or the like at an end of shaft 216 configured to be received at the mechanical connection interface 214.

Plunger handle 218 can be provided at an end of shaft 216 opposite the plunger 210. Plunger handle 218 can provide an area where plunger assembly 208 can be engaged to move plunger 210 within the body 202. In an embodiment, plunger handle 218 can be formed integrally with shaft 216. In an embodiment, plunger handle 218 can be connected to shaft 216 by any suitable method such as any suitable mechanical connection, adhesives, welding, or the like. The plunger handle 218 can have a diameter larger than a diameter of shaft 216.

Cap 224 can optionally be used with apparatus 200. Cap 224 can be used to cover connector 206 and optionally some or all of tapered tip 204, for example during transport or centrifuging of apparatus 200. Cap 224 can be configured to be received in a centrifuge such that apparatus 200 can be held securely in the centrifuge and the centrifuge can be used to separate contents of apparatus 200. Cap 224 can be configured to fit securely on apparatus 200, for example forming an interference or snap fit on body 202, for example at tapered tip 204.

Optionally, the apparatus 200 can be connected to a fluid storage 226 by way of one of first fluid passage 220 or second fluid passage 222. In an embodiment, the connection can be made by attaching a tube from the fluid storage 226 to the tube retention such as hose barbs, luer connections, or the like, provided on the first or second fluid passages 220, 222. The fluid storage 226 can be configured to store or receive bioreaction fluid. In an embodiment, the fluid storage 226 is a bag containing bioreaction fluid that has been thawed following cryogenic storage or processing steps. In an embodiment, the thawed bioreaction fluid can include a cryoprotectant, media, and cells. In an embodiment, the fluid storage 226 contains media for cells of the thawed bioreaction fluid that does not include cryoprotectant. In an embodiment, fluid storage 226 can include multiple separate sources of fluid to be combined in apparatus 200.

Optionally, the apparatus 200 can be connected to a vacuum source 228 by way of one of first fluid passage 220 or second fluid passage 222. The connection can be made by attaching a tube from vacuum source 228 to the tube retention provided on first or second fluid passage 220, 222. In an embodiment, vacuum source 228 can include a filter. In an embodiment, vacuum source 228 can be used to provide a vacuum to draw fluid from fluid storage 226 into body 202. In an embodiment, vacuum source 228 can be replaced with ventilation allowing pressure to be relieved when fluid is transferred into body 202 from fluid storage 226.

FIG. 3 shows a system for transfer of fluids according to an embodiment. System 300 includes first fluid transfer apparatus 310 and second fluid transfer apparatus 350. In the embodiment shown in FIG. 3, first fluid transfer apparatus 310 and second fluid transfer apparatus 350 are each an apparatus 100 as described above and shown in FIG. 1. The connector 312 of first fluid transfer apparatus 310 and the connector 352 of second fluid transfer apparatus 350, allowing fluid to be transferred between first fluid transfer apparatus 310 and second fluid transfer apparatus 350. In an embodiment, the connectors 312, 352 form a swabable valve, allowing fluid flow through each of the connectors 312, 352 only when the connectors 312 are connected to one another. In the embodiment shown in FIG. 3, the transfer of fluids between the first fluid transfer apparatus 310 and the second fluid transfer apparatus 350 can be driven by the application of positive or negative pressure to the internal spaces of first fluid transfer apparatus 310 and/or second fluid transfer apparatus 350 by way of a first pressure source 314 connected to pressure control connector 316 provided on first fluid transfer apparatus 310 and/or a second pressure source 354 connected to pressure control connector 356 provided on second fluid transfer apparatus 350. In an embodiment, apparatuses 310 and 350 can instead be apparatuses according to apparatus 200 described above and shown in FIG. 2, with the application of positive or negative pressure being achieved through operating plunger assembly 208 to increase or decrease a volume of the internal space defined by body 202 and plunger 210.

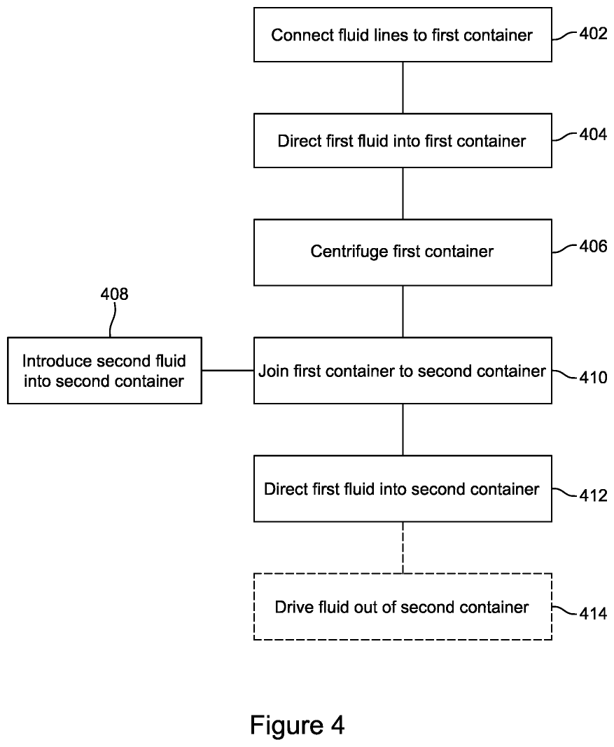

FIG. 4 shows a flowchart of a method for clean transfer of fluids according to an embodiment. Method 400 includes connecting one or more fluid lines to fluid passages of a first fluid transfer container 402, directing a first fluid through at least one of the one or more fluid lines into the transfer container, the first fluid including previously frozen cells and first media, the first media including a cryoprotectant 404, centrifuging the first fluid transfer container when it contains the first fluid 406, introducing a second fluid into a second fluid transfer container 408, and connecting the first fluid transfer container to the second fluid transfer container 410. A portion of the first fluid can then be directed from the first fluid transfer container to the second fluid transfer container 412. Method 400 can optionally further include driving fluid out of the second fluid transfer container 414.

Method 400 includes connecting one or more fluid lines to fluid passages of a first fluid transfer container 402. The fluid passages can be, for example, fluid passages 108 or 110 as shown in FIG. 1 and described above or fluid passages 220 or 222 as described above and shown in FIG. 2. The connection can be made by way of any suitable fluid line connection provided on the fluid transfer container, such as hose barbs, luer connections, or the like. The connection allows fluid to be introduced to an internal space of the first fluid transfer container by way of the one or more fluid lines.

Method 400 further includes directing a first fluid through at least one of the one or more fluid lines into the transfer container at 404. The first fluid includes previously frozen cells and first media. The first media includes a cryoprotectant. The cryoprotectant can be any suitable cryoprotectant compound used when freezing cells. The fluid can be provided from one or more fluid sources, such as a bag containing previously frozen cells and media, a storage containing additional media, or the like.

The first fluid transfer container is centrifuged when it contains the first fluid 406. The first fluid transfer container can be inserted into a centrifuge machine and spun to separate contents of the fluid contained within the first fluid transfer container. Optionally, a cap can be placed over the first fluid transfer container. The cap can protect features of the first fluid transfer container such as a connector, facilitate insertion and retention of the first fluid transfer container in the centrifuge, or the like. The centrifugation can separate the first fluid into a cell-rich fraction containing a relatively greater proportion of the thawed cells from a media-rich fraction containing a relatively greater proportion of the first media. The cell-rich fraction can be formed at a portion of the first fluid transfer container proximate to the connector such as connector 106 or 206 as described above and shown in FIGS. 1 and 2, respectively.

Method 400 can further include introducing a second fluid into a second fluid transfer container 408. The second fluid includes a second media. The second media can be any suitable media for the previously frozen cells included in the first fluid. The second media contains a lower concentration of the cryoprotectant than the first media in the first fluid transfer container. In an embodiment, the second media does not contain any cryoprotectants.

The first fluid transfer container is connected to the second fluid transfer container at 410. The connection can be made by way of connectors provided on each of the fluid transfer containers, such as the connectors 106 and 206 described above and shown in FIGS. 1 and 2, respectively. The connectors can be configured to allow flow only when two connectors are connected to one another. In an embodiment, the connectors of the first and second fluid transfer containers form a swabable valve allowing fluid to pass between the first and second fluid transfer containers when they are connected.

A portion of the first fluid can then be directed from the first fluid transfer container to the second fluid transfer container at 412. The first fluid passes through the connection formed at 410 to pass from the first fluid transfer container to the second fluid transfer container. The portion of the first fluid that is directed from the first fluid transfer container to the second fluid transfer container can include some or all of the cell-rich fraction obtained by the centrifugation at 406. Optionally, the portion of the first fluid that is transferred from the first fluid transfer container to the second fluid transfer container includes some of the media-rich fraction in addition to the cell-rich fraction. The portion of the first fluid that is transferred from the first fluid transfer container to the second fluid transfer container can mix with the second media in the second fluid transfer container. This results in a mixing of the thawed cells and some of the first media with the second media, thus resulting in the thawed cells being in a media having a lower concentration of cryoprotectants compared to when the cells were in the first fluid.

Optionally, the fluid in the second fluid transfer container can be removed at 414. The fluid can be removed from second fluid transfer container to continue through a process such as a bioreaction process. The fluid can be removed from the second fluid transfer container by, for example, connection of fluid lines to fluid passages 108 or 110 as shown in FIG. 1 and described above or fluid passages 220 or 222 as described above and shown in FIG. 2, and use of those fluid connections to remove the fluid from the second transfer container. The removed fluid can include the media and the thawed cells.

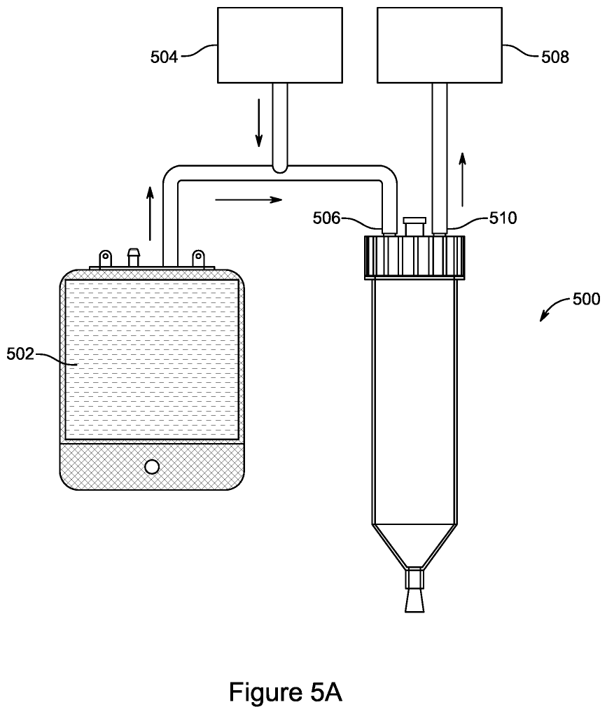

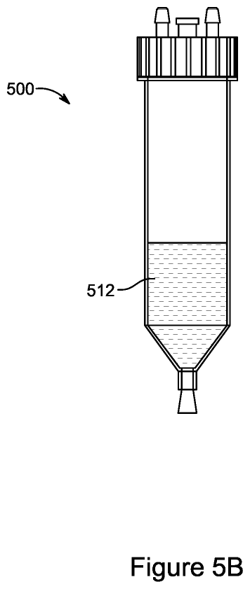

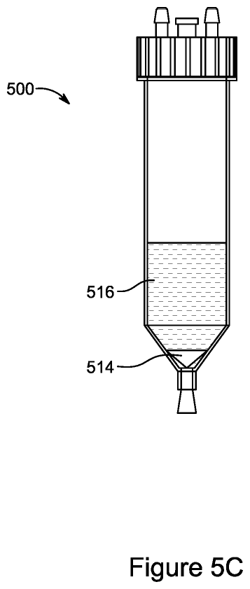

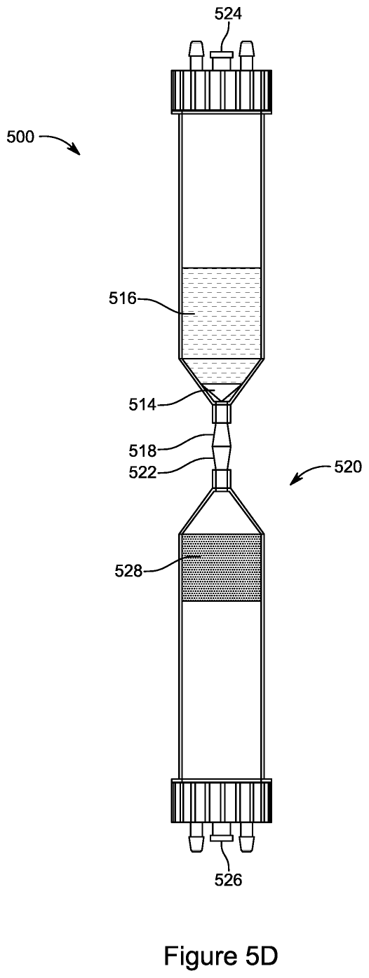

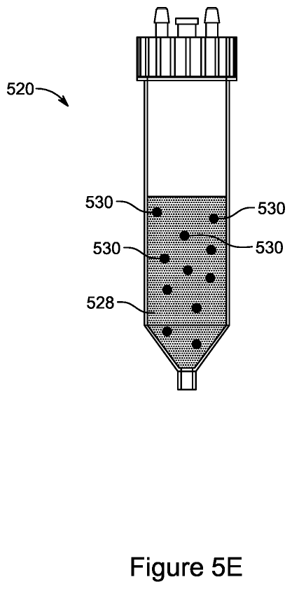

FIG. 5A shows a system for transfer of fluids during filling of an apparatus for fluid transfer according to an embodiment. First fluid transfer container 500 is connected to thawed cell container 502 and media source 504 at first fluid passage 506. Vacuum source 508 is connected to second fluid passage 508. This allows media from media source 504 and the thawed cells from 502 to both be introduced into the internal space of first fluid transfer container 500.

First fluid transfer container 500 can subsequently be disconnected from thawed cell container 502, media source 504, and vacuum source 508. FIG. 5B shows an apparatus for transfer of fluids according to an embodiment when it contains fluid prior to centrifugation. The media from media source 504 and thawed cells from 502 as shown in FIG. 1 are together in first mixture 512.

The first fluid transfer container 500 can then be centrifuged. FIG. 5C shows an apparatus for transfer of fluids according to an embodiment when it contains fluid following centrifugation. Centrifugation separates first mixture 512 into cell-rich fraction 514 and media-rich fraction 516, with cell-rich fraction 514 containing relatively more of the thawed cells and media-rich fraction 516 containing relatively more of the media.

FIG. 5D shows an apparatus for transfer of fluids when it is included in a system for transfer of fluids according to an embodiment. First fluid transfer container 500 containing the cell-rich fraction 514 and media-rich fraction 516 is connected to second fluid transfer container 520 by way of connector 518 provided on first fluid transfer container 500 and connector 522 provided on second fluid transfer connector 522. Connectors 518 and 522 can combine to allow fluid to flow from first fluid transfer container 500 to second fluid transfer container 520, for example by opening a swabable valve when the connectors 518, 522 are joined to one another. At least a portion of the contents of first fluid transfer container 500 can be expelled from first fluid transfer container 500 to second fluid transfer container 520. The portion that is expelled from first fluid transfer container can include some or all of the cell-rich fraction 514 and optionally some of the media-rich fraction 516. The expelling of the portion can be achieved by attaching a pressure source, such as a syringe, a pressurized fluid line, or the like to pressure control connector 524 of first fluid transfer container 500 and applying positive pressure to the interior space of the first fluid transfer container 500. In an embodiment, the first fluid transfer container can instead be an apparatus such as apparatus 200 shown in FIG. 2, and the expelling of the portion could be achieved through depressing the plunger 210 to reduce the volume of the internal space defined by the plunger 210 and body 202 as described above and shown in FIG. 2. In an embodiment, the expelling of the portion from the first fluid transfer container 500 can be achieved by providing a negative pressure at the second fluid transfer container 520 to draw fluid into the second fluid transfer container, for example by drawing a plunger to increase a volume of the internal space, or providing negative pressure through a pressure source connected to pressure control connector 526 of the second fluid transfer container 520. The fluid expelled from the first fluid transfer container 500 can mix with lower-cryoprotectant media 528 contained within the second fluid transfer container 520. The lower-cryoprotectant media 528 can be media suitable for the thawed cells from 502 that contains no cryoprotectant or contains cryoprotectant at concentrations lower than the concentration of cryoprotectant than were present in first mixture 512.

FIG. 5E shows the second fluid transfer container 520, following transfer of the fluid from first fluid transfer container 500. First fluid transfer container 500 and any remaining fluid contained therein, such as the media-rich fraction 516, can be discarded or optionally first fluid transfer container 500 flushed and cleaned for subsequent use. Second fluid transfer container 520 includes the cells 530 from cell-rich portion 514 dispersed in lower-cryoprotectant media 528.

Aspects:

It is understood that any of aspects 1-11 can be combined with any of aspects 12-18.

Aspect 1. A fluid transfer system comprising:

a first fluid transfer container, the first fluid transfer container including:

a tube, the tube including a conical portion at one end, the tube defining an interior space;

one or more fluid passages configured to allow flow of fluid into or out of the interior space of the tube;

a connector disposed at an end of the conical portion, the connector configured to seal the end of the conical portion when the connector is joined only to the conical portion; and
a pressure control mechanism configured to increase or decrease a pressure in the interior space of the tube.

Aspect 2. The fluid transfer system according to aspect 1, wherein the connector includes at least part of a swabable valve.

Aspect 3. The fluid transfer system according to any of aspects 1-2, further comprising a cap configured to cover the connector and at least part of the conical portion.

Aspect 4. The fluid transfer system according to aspect 3, wherein the cap is configured to be received in a centrifuge.

Aspect 5. The fluid transfer system according to any of aspects 1-4, further comprising a transfer assembly and a fluid line connected to the transfer assembly and to one of the one or more fluid passages.

Aspect 6. The fluid transfer system according to any of aspects 1-5, further comprising a media supply and a fluid line connected to the media supply and to one of the one or more fluid passages.

Aspect 7. The fluid transfer system according to any of aspects 1-6, further comprising a vent including a filter, and a fluid line connected to the vent and to one of the one or more fluid passages.

Aspect 8. The fluid transfer system according to any of aspects 1-7, wherein the pressure control mechanism includes a plunger movably disposed within the tube, wherein:

the one or more fluid passages are disposed on the plunger,
the plunger includes a socket, and
the pressure control mechanism further includes a plunger handle configured to be attached to the plunger at the socket, the plunger handle configured such that a space is formed between the plunger handle and the tube, the space configured to accommodate one or more fluid lines configured to be joined to the one or more fluid passages.

Aspect 9. The fluid transfer system according to any of aspects 1-8, wherein the pressure control mechanism is a syringe including a syringe tube, a plunger, and a luer connector, the luer connector configured to be connected to a transfer container luer connector provided on the transfer container.

Aspect 10. The fluid transfer system according to any of aspects 1-9, further comprising a second fluid transfer container, the second fluid transfer container including:

a second tube, the second tube including a second conical portion at one end, the second tube defining a second internal space; and
a second connector disposed at an end of the second conical portion, the connector configured to seal the end of the second conical portion when the connector is joined only to the second conical portion,
wherein the connector of the first fluid transfer container and the second connector are configured to be joined to one another.

Aspect 11. The fluid transfer system according to aspect 11, wherein the connector of the first fluid transfer container forms a first portion of a swabable valve and the second connector forms a second portion of the swabable valve.

Aspect 12. A method of handling a fluid, comprising:

connecting one or more fluid lines to fluid passages of a first fluid transfer container;

directing a first fluid through at least one of the one or more fluid lines into the transfer container, the first fluid including previously frozen cells and first media, the first media including a cryoprotectant;

centrifuging the first fluid transfer container when it contains the first fluid;

introducing a second fluid into a second fluid transfer container, the second fluid including a second media, the second media containing a lower concentration of the cryoprotectant than the first media;

connecting the first fluid transfer container to the second fluid transfer container; and transferring at least a portion of the first fluid into the second fluid transfer container.

Aspect 13. The method according to aspect 12, further comprising placing a cap over the first connector prior to the centrifuging of the syringe.

Aspect 14. The method according to any of aspects 12-13, connecting the first fluid transfer container to the second fluid transfer container comprises joining the first connector to a second connector of a second fluid transfer container.

Aspect 15. The method according to aspect 14, wherein the first connector is a first portion of a swabable valve, and the second connector is a second portion of the swabable valve.

Aspect 16. The method according to any of aspects 12-15, wherein the second media does not contain any of the cryoprotectant.

Aspect 17. The method according to any of aspects 12-16, further comprising directing the previously frozen cells and the second media out of the second fluid transfer container by pressurizing an internal space of the second fluid transfer container, wherein the internal space of the second fluid transfer container is pressurized by driving a plunger located within the internal space of the second fluid transfer container.

Aspect 18. The method according to any of aspects 12-17, further comprising directing the previously frozen cells and the second media out of the second fluid transfer container by pressurizing an internal space of the second fluid transfer container, wherein the internal space of the second fluid transfer container is pressurized by driving a plunger of a syringe, the syringe being fluidly connected to the second fluid transfer container by way of a luer connection.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fluid transfer system comprising:
a first fluid transfer container, the first fluid transfer container including:
a tube, the tube including a conical portion at one end, the tube defining an interior space;
one or more fluid passages configured to allow flow of fluid into or out of the interior space of the tube;
a connector disposed at an end of the conical portion, the connector configured to seal the end of the conical portion when the connector is joined only to the conical portion; and
a pressure control mechanism configured to increase or decrease a pressure in the interior space of the tube.

2. The fluid transfer system of claim 1, wherein the connector includes at least part of a swabable valve.

3. The fluid transfer system of claim 1, further comprising a cap configured to cover the connector and at least part of the conical portion.

4. The fluid transfer system of claim 3, wherein the cap is configured to be received in a centrifuge.

5. The fluid transfer system of claim 1, further comprising a transfer assembly and a fluid line connected to the transfer assembly and to one of the one or more fluid passages.

6. The fluid transfer system of claim 1, further comprising a media supply and a fluid line connected to the media supply and to one of the one or more fluid passages.

7. The fluid transfer system of claim 1, further comprising a vent including a filter, and a fluid line connected to the vent and to one of the one or more fluid passages.

8. The fluid transfer system of claim 1, wherein the pressure control mechanism includes a plunger movably disposed within the tube, wherein:
the one or more fluid passages are disposed on the plunger,
the plunger includes a socket, and
the pressure control mechanism further includes a plunger handle configured to be attached to the plunger at the socket, the plunger handle configured such that a space is formed between the plunger handle and the tube, the space configured to accommodate one or more fluid lines configured to be joined to the one or more fluid passages.

9. The fluid transfer system of claim 1, wherein the pressure control mechanism is a syringe including a syringe tube, a plunger, and a luer connector, the luer connector configured to be connected to a transfer container luer connector provided on the transfer container.

10. The fluid transfer system of claim 1, further comprising a second fluid transfer container, the second fluid transfer container including:
a second tube, the second tube including a second conical portion at one end, the second tube defining a second internal space; and
a second connector disposed at an end of the second conical portion, the connector configured to seal the end of the second conical portion when the connector is joined only to the second conical portion,
wherein the connector of the first fluid transfer container and the second connector are configured to be joined to one another.

11. The fluid transfer system of claim 10, wherein the connector of the first fluid transfer container forms a first portion of a swabable valve and the second connector forms a second portion of the swabable valve.

12. A method of handling a fluid, comprising:
connecting one or more fluid lines to fluid passages of a first fluid transfer container;
directing a first fluid through at least one of the one or more fluid lines into the transfer container, the first fluid including previously frozen cells and first media, the first media including a cryoprotectant;
centrifuging the first fluid transfer container when it contains the first fluid;
introducing a second fluid into a second fluid transfer container, the second fluid including a second media, the second media containing a lower concentration of the cryoprotectant than the first media;
connecting the first fluid transfer container to the second fluid transfer container; and
transferring at least a portion of the first fluid into the second fluid transfer container.

13. The method of claim 12, further comprising placing a cap over the first connector prior to the centrifuging of the syringe.

14. The method of claim 12, wherein connecting the first fluid transfer container to the second fluid transfer container comprises joining the first connector to a second connector of a second fluid transfer container.

15. The method of claim 14, wherein the first connector is a first portion of a swabable valve, and the second connector is a second portion of the swabable valve.

16. The method of claim 12, wherein the second media does not contain any of the cryoprotectant.

17. The method of claim 12, further comprising directing the previously frozen cells and the second media out of the second fluid transfer container by pressurizing an internal space of the second fluid transfer container, wherein the internal space of the second fluid transfer container is pressurized by driving a plunger located within the internal space of the second fluid transfer container.

18. The method of claim 12, further comprising directing the previously frozen cells and the second media out of the second fluid transfer container by pressurizing an internal space of the second fluid transfer container, wherein the internal space of the second fluid transfer container is pressurized by driving a plunger of a syringe, the syringe being fluidly connected to the second fluid transfer container by way of a luer connection.
